(19) United States
(12) Patent Application Publication
(10) Pub. No.: US 2016/0048844 A1
(43) Pub. Date: Feb. 18, 2016

(54) TECHNIQUES, ARCHITECTURES AND MECHANISMS FOR MANAGEMENT OF ELECTRONIC LICENSURE

(71) Applicant: salesforce.com, inc., San Francisco, CA (US)

(72) Inventors: John F. Vogt, JR., San Francisco, CA (US); Bhadri Narayanan Venkatesan, Foster City, CA (US); Thomas William D'Silva, Fremont, CA (US); Belinda Wong, San Bruno, CA (US)

(21) Appl. No.: 14/461,108

(22) Filed: Aug. 15, 2014

(51) Int. Cl. G06Q 30/00

(52) U.S. Cl. CPC G06Q 30/018

(57) ABSTRACT

Techniques for updating license information within a multitenant on-demand services environment where the license information is not automatically updated from a production organization to a sandbox organization and the sandbox organization is a sub-tenant of the production organization and the sandbox organization and the production organization utilize different logical databases. A request is received for updating licenses within the sandbox organization. Updated license information is requested from the production organization by making a cross-instance call. The updated license information is received from the production organization. The licenses are updated within the sandbox. License aggregation is initialized utilizing the updated licenses within the sandbox. The license aggregation requires a higher level of authorization than the requesting the updated license information.

### TECHNICAL FIELD

Embodiments relate to management of electronic licenses. More particularly embodiments relate to keeping licensing information current.

### BACKGROUND

It is very common for electronic resources (e.g., databases, applications, data access, processing services, media ownership/use) to require a license for use. These licenses can take various forms and are managed using various techniques. In large organizations and/or situations where many different licenses are required, management of the licenses required for full resource utilization can be complex.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual diagram of a system and technique for updating licensing information.

FIG. 2 is a flow diagram of one embodiment for a technique for updating licensing information.

FIG. 3 is a block diagram of one embodiment of a license update tool/agent.

FIG. 4 is a block diagram of one environment wherein an on-demand database service might be used.

FIG. 5 is a block diagram of one embodiment of elements of environment of FIG. 4 and various possible interconnections between these elements.

### DETAILED DESCRIPTION

In the following description, numerous specific details are set forth. However, embodiments of the invention may be practiced without these specific details. In other instances, structures and techniques have not been shown in detail in order not to obscure the understanding of this description.

In one embodiment, license management may be provided within an on-demand services environment that utilizes organization identifiers (IDs) within a multi-tenant environment to allow individual tenants to access their data while preserving the integrity of other tenant's data. In one embodiment, the on-demand services environment stores data for multiple client entities each identified by a organization ID having one of one or more users associated with the organization ID. Users of each of multiple client entities can only access data identified by an organization ID associated with their respective client entity. The on-demand services environment can provide, for example, a multitenant database environment. In one embodiment, the multitenant database is a hosted database provided by an entity separate from the client entities, and provides on-demand and/or real-time database service to the client entities.

In one embodiment, tenants may have one or more sandboxes that can be utilized with the multitenant environment. In one embodiment, sandboxes provide the ability to create multiple copies of a tenant's data and/or service environment in separate environments for a variety of purposes, such as development, testing, and training, without compromising the data and applications in a production organization. In one embodiment, sandboxes are isolated from the production organization, so operations that are performed in the sandboxes do not affect the production organization, and vice versa.

In one embodiment, sandboxes are nearly identical to the production organization. In one embodiment, Sandbox and production organizations have unique organization IDs. A sandbox copy engine creates a new organization as part of each creation and refresh request. So, the organization ID of a sandbox changes each time the sandbox is refreshed. In one embodiment, sandbox organizations can be created on several instances. When a sandbox is created or refreshed, an instance is selected for the sandbox, so the sandbox organizations may appear on different instances and have different locators Uniform Resource Locators, URLs).

In one embodiment, when data is copied to a sandbox, object IDs (the unique identifiers for all objects) for existing records are copied to the sandbox as part of those records. After being copied, however, object IDs do not synchronize between the production organization and the sandbox. The sandbox and its corresponding production organization act as independent organizations. Object data (and corresponding object IDs) that are created in the production organization after the creation or refresh of a sandbox are not synchronized into the sandbox. The sandbox has the same behavior new objects that are created in the sandbox are not synchronized back to the production organization.

In one embodiment, User information is included in a sandbox copy or refresh for all sandbox types. Because usernames may be unique and reference a single organization, copied usernames can be modified to ensure uniqueness during the copy process. In one embodiment, sandbox copy is a relatively long-running operation that occurs in the background,

As discussed above, data (including licensing information) is copied at the time of sandbox creation. If, after sandbox creation, the organization/user acquires additional licenses (e.g., by purchasing new modules/functionality/services), those newly-acquired licenses are not automatically copied to the sandbox. Because the sandbox is on a different logical database than the original (“production”) database, the underlying database tables are not shared and copying the licenses requires copying rows of data from the production database. One way to accomplish this is by refreshing the sandbox, which copies the production database to the sandbox. However, this is time consuming and may interfere with the functionality of the sandbox during the refresh operation.

In one embodiment, in response to a “match licenses” (or similar) input, a license copy tool enqueues a message using, for example, a message queue framework in the sandbox application server, to copy licenses from the production instance. In one embodiment, the message causes a license copy message handler to copy (or update) license information.

When using a queued messaging system, the message can be dequeued by the license copy message handler that starts the copy operation. In one embodiment, the license copy message handler deletes the data from the license tables in the database for the sandbox. In one embodiment, the license copy message handler makes a cross-instance (e.g., Simple Object Access Protocol, or SOAP) call to the production database to fetch the license data. If using SOAP, for example, license data can be fetched in chunks to ensure the payload fits within SOAP call limits. The license data is inserted in to the sandbox database. In one embodiment, the license copy message handler initiates license aggregation, which enables the license in the sandbox organization.

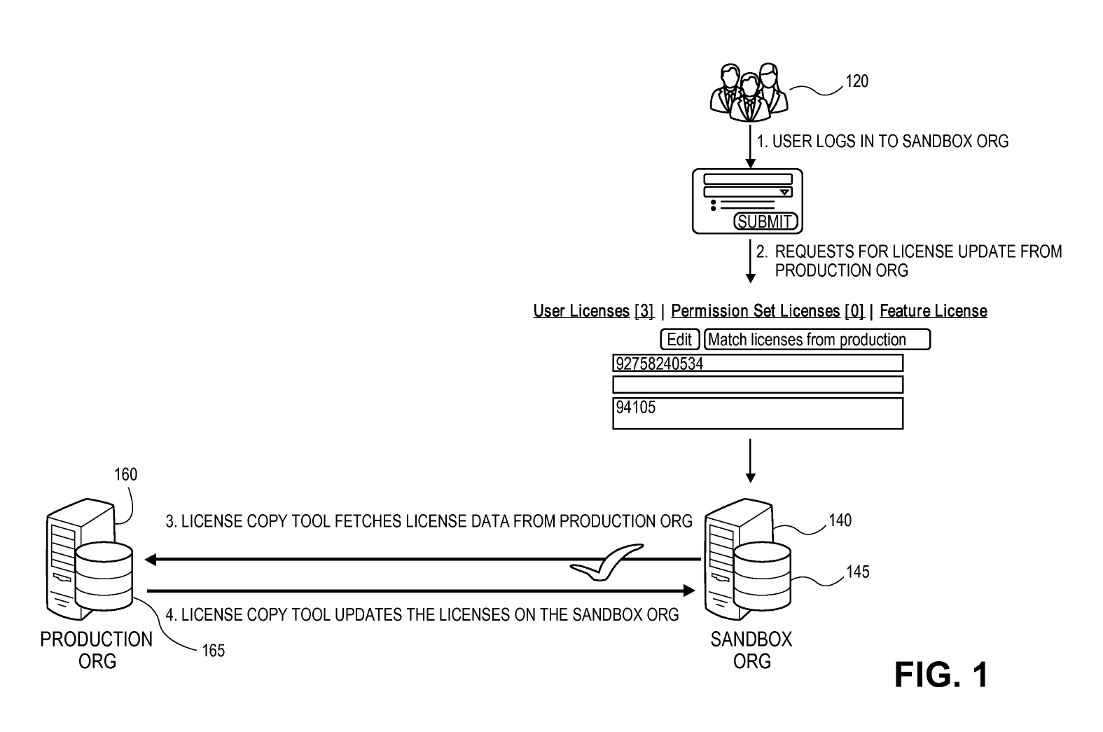

FIG. 1 is a conceptual diagram of a system and technique for updating licensing information. FIG. 1 illustrates a license copy tool/mechanism that can fetch license data from a production database/organization and update the license information in the sandbox database/organization. The example of FIG. 1 provides updated information in response to a user requesting updated license information via a graphical user interface; however, updating of license information can be initiated in other ways as well.

In one embodiment, user 120 logs in to a sandbox organization. As discussed above, a sandbox organization is a copy of the corresponding production organization as of the time of creation, but is thereafter independent of the production organization. Because the sandbox organization is independent of the production organization, licenses acquired by the production organization are not automatically replicated to the sandbox organization.

In one embodiment, once user 120 is logged in to the sandbox organization, user 120 can request a license update from the production organization. In one embodiment, user 120 is provided with a graphical user interface to access the functionality of the sandbox organization and this graphical user interface can provide the option (e.g., menus, buttons, lists and/or prompts) to update license information.

In one embodiment, in response to the request to update the license information, sandbox organization 140 utilizes a license copy tool to fetch updated license information from production organization 160. In one embodiment, the license copy tool causes a license copy message handler to copy (or update) license information.

When using a queued messaging system, the message can be dequeued by the license copy message handler that starts the copy operation. In one embodiment, the license copy message handler deletes the data from the license tables in sandbox organization database 145 for sandbox organization 140. In one embodiment, the license copy message handler makes a cross-instance (e.g., Simple Object Access Protocol, or SOAP) call to production organization 160 to fetch the license data stored in production organization database 165. If using SOAP, for example, license data can be fetched in chunks to ensure the payload fits within SOAP call limits. The license data is inserted in to sandbox organization database 145.

In one embodiment, only license information is copied from production organization database 165 to sandbox organization database 145. Thus, the license update does not refresh the data corresponding to sandbox organization 140. In one embodiment, supporting information related to licenses can also be included in the update. This allows the license information to be updated without losing or corrupting data that has been saved to sandbox organization database 145 after creation of sandbox organization 140.

In one embodiment, the license copy message handler initiates license aggregation, which enables the license in sandbox organization 140. In one embodiment, license aggregation requires a higher privilege level than requesting an update to the license information.

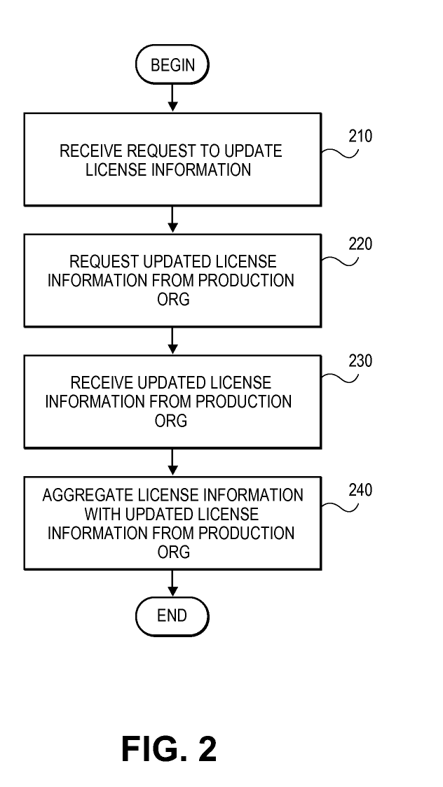

FIG. 2 is a flow diagram of one embodiment for a technique for updating licensing information. In the example of FIG. 2, the operations described are generally performed by/within the sandbox organization. In other embodiments, one or more of the operations may be performed by the production organization and/or by other system components.

In one embodiment, a user can request a license update, 210. As discussed above, this can be accomplished via a graphical user interface. In one embodiment, a user is provided with a graphical user interface to access the functionality of the sandbox organization and this graphical user interface can provide the option (e.g., menus, buttons, lists and/or prompts) to update license information. For example, a portion of the graphical user interface can include a “match licenses from production” button or option.

One or more components within the sandbox organization can operate to request updated license information from the production organization, 220. In one embodiment, the sandbox organization/environment can include a sandbox license update tool/agent that can function to update license information within the sandbox organization/environment.

In response to the request for updated license information, the production organization/environment operates to provide updated license information. In one embodiment, the production organization/environment can include a production license update tool/agent that can function to respond to requests for updated license information by providing the requested license information.

In one embodiment, in response to a request for updated license information, the production license update tool/agent copies information corresponding to one or more licenses in the production organization/environment and provides the license information to the requesting sandbox organization/environment. The sandbox organization/environment receives the updated license information from the production organization/environment, 230.

In response to receiving the updated license information, the sandbox license update tool/agent operates to update the database entries corresponding to the licensing information. The sandbox organization will then have the information for the licenses as of the time that the production organization responded to the request for updated license information.

In one embodiment, after the license information has been updated, the sandbox organization aggregates the updated license information, 240. In one embodiment, this aggregation requires a higher privilege level than requesting the updated license information. Aggregation of the license information includes providing the increased functionality (if any) resulting from the update to the licensing information. For example, new functionality, modules, applications, resources and/or accesses may be provided as a result of the updated license information.

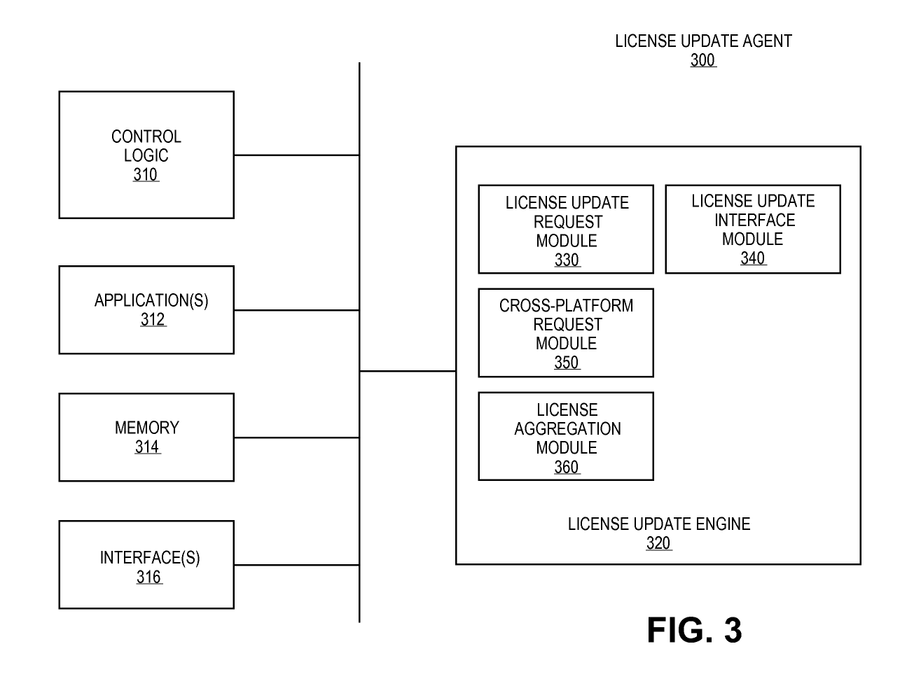

FIG. 3 is a block diagram of one embodiment of a license update tool/agent. License update tool/agent 300 includes control logic 310, which implements logical functional control to direct operation of license update tool/agent 300, and/or hardware associated with directing operation of license update tool/agent 300. Logic may be hardware logic circuits and/or software routines. In one embodiment, license update tool/agent 300 includes one or more applications 312, which represent code sequence and/or programs that provide instructions to control logic 310.

License update tool/agent 300 includes memory 314, which represents a memory device and/or access to a memory resource for storing data and/or instructions. Memory 314 may include memory local to license update tool/agent 300, as well as, or alternatively, including memory of the host system on which license update tool/agent 300 resides. License update tool/agent 300 also includes one or more interfaces 316, which represent access interfaces to/from (an input/output interface) license update tool/agent 300 with regard to entities (electronic or human) external to license update tool/agent 300.

License update tool/agent 300 also includes license update engine 320, which represents one or more functions or modules that enable license update tool/agent 300 to provide the search services as described above. The example of FIG. 3 provides several modules that may be included in license update engine 320; however, different and/or additional modules may also be included.

Example modules that may be involved in providing the license update functionality include license update request module 330, license update interface module 340, cross-platform request module 350 and license aggregation module 360. Each of these modules may further include other sub-modules to provide other functions. As used herein, a module refers to routine, a subsystem, logic circuit, microcode, etc., whether implemented in hardware, software, firmware or some combination thereof.

License update interface module 340 provides one or more components of a graphical user interface a user experiences when requesting a license update for a sandbox organization, for example, in a multitenant database environment. License update interface module 340 may provide at least one button, menu option, selection and/or field configured to receive user-generated input indicating a license update to be performed.

License update request module 330 operates to request updated license information from a production organization in response to a request received via license update interface module 340. License update interface module 340 may operate as described above.

Cross-platform request module 350 operates to issue cross-platform requests from the sandbox organization to the production organization to retrieve updated license information. In one embodiment, cross-platform request module 350 also receives responses from the production organization to receive the requested updated license information. License aggregation module 360 operates to update functionality within the sandbox organization based on the updated license information received from the production organization.

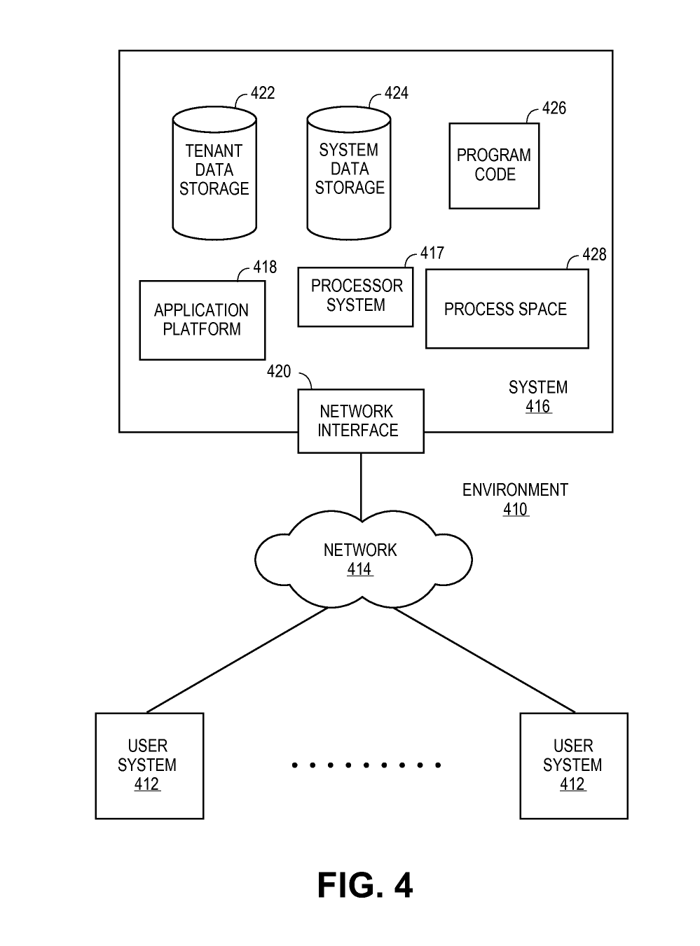

FIG. 4 illustrates a block diagram of an environment 410 wherein an on-demand, multitenant database service might be used. Environment 410 may include user systems 412, network 414, system 416, processor system 417, application platform 418, network interface 420, tenant data storage 422, system data storage 424, program code 426, and process space 428. In one embodiment, multitenant environment 410 may include multitenant search engine 430 that may operate as described herein. In other embodiments, environment 410 may not have all of the components listed and/or may have other elements instead of, or in addition to, those listed above.

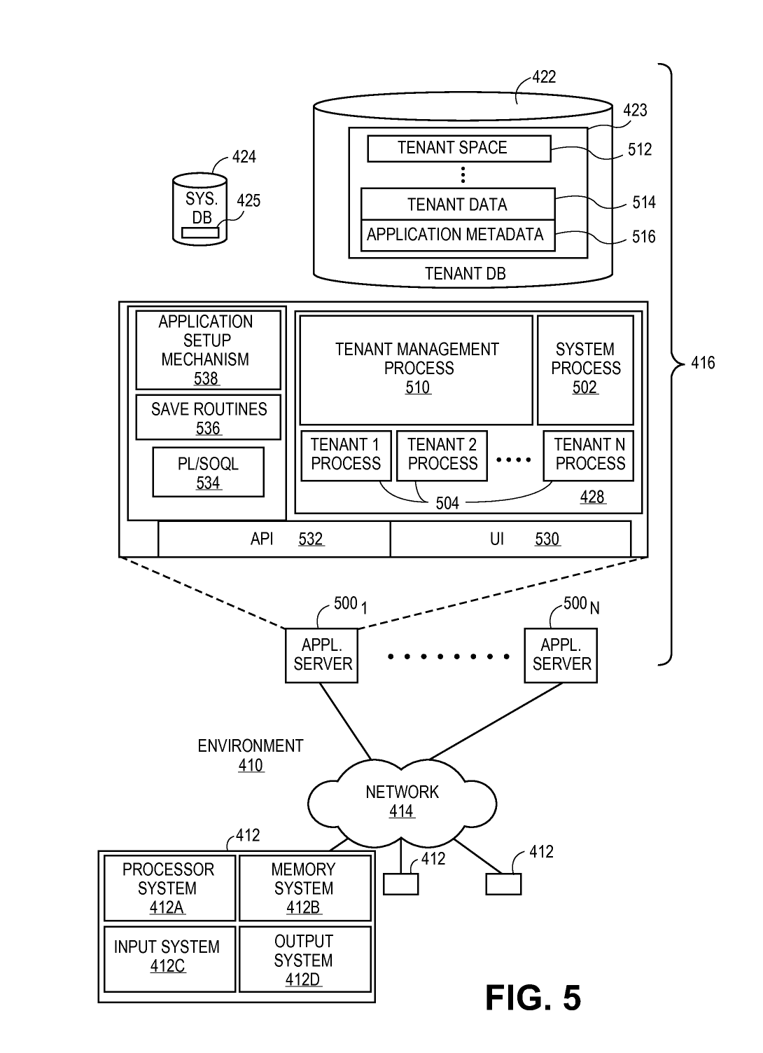

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network 414 with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein.

A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, web pages and other information to and from user systems 412 and to store to, and retrieve from, a database system related data, objects, and web page content.

With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 416 implements applications other than, or in addition to, a CRM application. For example, system 16 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414.

Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417, which may include an Intel Pentium® processor or the like, and/or multiple processor units.

A computer program product embodiment includes a machine-readable storage medium (media) having instructions stored thereon/in which can be used to program a computer to perform any of the processes of the embodiments described herein. Computer code for operating and configuring system 416 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known.

It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide web pages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 412B, input system 412C, and output system 412D. FIG. 5 shows network 414 and system 416.

FIG. 5 also shows that system 416 may include tenant data storage 422, tenant data 423, system data storage 424, system data 425, User Interface (UI) 530, Application Program Interface (API) 532, PL/SOQL 534, save routines 536, application setup mechanism 538, applications servers 500₁-1000_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 5. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks. As shown by FIG. 5, system 416 may include a network interface 420 (of FIG. 4) implemented as a set of HTTP application servers 500, an application platform 418, tenant data storage 422, and system data storage 424.

Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514.

Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle' databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532.

A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500.

Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for updating license information within a multitenant on-demand services environment, wherein the license information is not automatically updated from a production organization to a sandbox organization, the sandbox organization is a sub-tenant of the production organization, and the sandbox organization and the production organization utilize different logical databases, the method comprising:
receiving a request for updating licenses within the sandbox organization;
requesting updated license information from the production organization by making a cross-instance call;
receiving the updated license information from the production organization;
updating the licenses within the sandbox; and
initiating license aggregation utilizing the updated licenses within the sandbox, wherein license aggregation requires a higher level of authorization than the requesting the updated license information.

2. The method of claim 1 wherein the sandbox organization comprises a copy of the production organization at a time of creation of the sandbox organization, and wherein the sandbox organization is isolated from the production organization after the time of creation of the sandbox organization so that operations performed in the sandbox operation do not affect the production organization.

3. The method of claim 1 wherein the sandbox organization comprises a copy of the production organization at a time of refresh of the sandbox organization, and wherein the sandbox organization is isolated from the production organization after the time of refresh of the sandbox organization so that operations performed in the sandbox operation do not affect the production organization.

4. The method of claim 1 wherein the receiving a request for updating licenses within the sandbox organization comprises receiving user input from within the sandbox organization.

5. The method of claim 1 wherein the production organization and the sandbox organization have different organization identifiers.

6. The method of claim 1 wherein the on-demand services environment comprises a multitenant database environment comprising a hosted database provided by an entity separate from the client entities that provides on-demand and/or real-time database service to the client entities.

7. A non-transitory computer-readable medium having instructions stored thereon that, when executed, cause one or more processors to update license information within a multitenant on-demand services environment, wherein the license information is not automatically updated from a production organization to a sandbox organization, the sandbox organization is a sub-tenant of the production organization, and the sandbox and organization and the production organization utilize different logical databases, the instructions comprising instructions that, when executed, cause the one or more processors to:
receive a request for updating licenses within the sandbox organization;
request updated license information from the production organization by making a cross-instance call;
receive the updated license information from the production organization;
update the licenses within the sandbox; and
initiate license aggregation utilizing the updated licenses within the sandbox, wherein license aggregation requires a higher level of authorization than the requesting the updated license information.

8. The non-transitory computer-readable medium of claim 7 wherein the sandbox organization comprises a copy of the production organization at a time of creation of the sandbox organization, and wherein the sandbox organization is isolated from the production organization after the time of creation of the sandbox organization so that operations performed in the sandbox operation do not affect the production organization.

9. The non-transitory computer-readable medium of claim 7 wherein the sandbox organization comprises a copy of the production organization at a time of refresh of the sandbox organization, and wherein the sandbox organization is isolated from the production organization after the time of refresh of the sandbox organization so that operations performed in the sandbox operation do not affect the production organization.

10. The non-transitory computer-readable medium of claim 7 wherein the receiving a request for updating licenses within the sandbox organization comprises receiving user input from within the sandbox organization.

11. The non-transitory computer-readable medium of claim 7 wherein the production organization and the sandbox organization have different organization identifiers.

12. The non-transitory computer-readable medium of claim 7 wherein the on-demand services environment comprises a multitenant database environment comprising a hosted database provided by an entity separate from the client entities that provides on-demand and/or real-time database service to the client entities.

13. A system to provide a multitenant on-demand services environment that is capable of updating license information, wherein the license information is not automatically updated from a production organization to a sandbox organization, where the sandbox organization is a sub-tenant of, and independent of, the production organization, and the sandbox organization and the production organization utilize different logical databases, the system comprising:
the sandbox organization to receive a request for updating licenses within the sandbox organization, to request updated license information from the production organization by making a cross-instance call, to receive the updated license information from the production organization, to update the licenses within the sandbox, and to initiate license aggregation utilizing the updated licenses within the sandbox, wherein license aggregation requires a higher level of authorization than the requesting the updated license information; and
the production organization communicatively coupled with the sandbox organization, the production organization to receive the request for updated license information and to provide the updated license information to the sandbox organization.

14. The system of claim 13 wherein the sandbox organization comprises a copy of the production organization at a time of creation of the sandbox organization, and wherein the sandbox organization is isolated from the production organization after the time of creation of the sandbox organization so that operations performed in the sandbox operation do not affect the production organization.

15. The system of claim 13 wherein the sandbox organization comprises a copy of the production organization at a time of refresh of the sandbox organization, and wherein the sandbox organization is isolated from the production organization after the time of refresh of the sandbox organization so that operations performed in the sandbox operation do not affect the production organization.

16. The system of claim 13 wherein the receiving a request for updating licenses within the sandbox organization comprises receiving user input from within the sandbox organization.

17. The system of claim 13 wherein the production organization and the sandbox organization have different organization identifiers.

18. The system of claim 13 wherein the on-demand services environment comprises a multitenant database environment comprising a hosted database provided by an entity separate from the client entities that provides on-demand and/or real-time database service to the client entities.
